(19) United States
(12) Patent Application Publication
(10) Pub. No.: US 2013/0278876 A1
(43) Pub. Date: Oct. 24, 2013

(54) LIQUID CRYSTAL DEVICE AND ELECTRONIC APPARATUS

(71) Applicant: SEIKO EPSON CORPORATION, Tokyo (JP)

(72) Inventor: Hiroyuki Oikawa, Chitose-shi (JP)

(73) Assignee: Seiko Epson Corporation, Tokyo (JP)

(21) Appl. No.: 13/861,786

(22) Filed: Apr. 12, 2013

(30) Foreign Application Priority Data
Apr. 24, 2012 (JP) 2012098460

(51) Int. Cl. G02F 1/1335

(52) U.S. Cl. CPC G02F 1/133512
USPC 349/110

(57) ABSTRACT

A liquid crystal device includes a first substrate, a second substrate, a liquid crystal interposed between the first substrate and the second substrate, a light blocking unit disposed in a region surrounding a display region when viewed in a direction toward the first substrate from the second substrate and a first region that surrounds the display region together with the light blocking unit. The first region is disposed toward the outer periphery of the first substrate and/or the second substrate from the display region, when viewed in the direction toward the first substrate from the second substrate.

### BACKGROUND

1. Technical Field

The present invention relates to a liquid crystal device, an electronic apparatus and the like.

2. Related Art

In the related art, a liquid crystal device is known which includes an element substrate on which a drive element such as a TFT (Thin Film Transistor) is provided, an opposing substrate disposed on opposing the element substrates and liquid crystal interposed between the element substrate and the opposing substrate. In such a liquid crystal device in the related art, it is known that a light blocking film which defines an outer periphery of an image display region is provided on the opposing substrate (For example, refer to JP-A-2010-48918).

In the liquid crystal device having the configuration described above, when light is incident on the liquid crystal device from the opposing substrate side, impurities may be accumulated between the opposing substrate and the element substrate and at a boundary between the light blocking film and the image display region. It is considered that it is because the impurities caused by a light irradiation are easily accumulated to the light blocking film side where light irradiation energy is weak compared to the image display region. Then, the accumulated impurities cause a burning phenomenon, which are likely to be visually recognized as a spot. Such a spot may be a factor decreasing a display quality of the liquid crystal device.

Thus, in the liquid crystal device in the related art, there is a problem in that the display quality is difficult to be improved.

### SUMMARY

The invention can be realized in the following forms or application examples.

### Application Example 1

A liquid crystal device includes a first substrate, a second substrate, a liquid crystal interposed between the first substrate and the second substrate, a light blocking unit disposed in a region surrounding a display region when viewed in a direction toward the first substrate from the second substrate, and a first region that surrounds the display region together with the light blocking unit. The first region is disposed toward the outer periphery of the first substrate and/or the second substrate from the display region, when viewed in the direction toward the first substrate from the second substrate. A light blocking film may not be disposed in the first region. In addition, impurities included in the liquid crystal may be accumulated in the first region.

In the liquid crystal device according to the application example, in the first region, a boundary between a light incidence and a light blocking can be kept away from the outside of the display region. Therefore, in a case where the impurities are accumulated in the first region, since the impurities can be kept away from the display region, it is possible to make the impurities hard to be visually recognized. In this way, it is possible to easily improve the display quality of the liquid crystal device.

### Application Example 2

In the liquid crystal device described above, the light blocking unit is disposed on the opposite surface to the light incident side surface of the first substrate.

In the application example, since the light blocking unit is provided on the opposite side surface with respect to the light incident side surface of the first substrate, a boundary between a light incidence and a light blocking of the light incident from the first substrate can be kept away from the outside of the display region. Therefore, in a case where the impurities are accumulated in the first region, since the impurities can be kept away from the display region, it is possible to make the impurities hard to be visually recognized.

### Application Example 3

In the liquid crystal device described above, the first region is provided so as to cut into a part of the light blocking unit.

In the application example, in a case where the impurities are accumulated on a position where the first region is provided so as to cut into a part of the light blocking unit, since the impurities can be kept away from the display region, it is possible to make the impurities hard to be visually recognized.

### Application Example 4

In the liquid crystal device described above, the first region is a slit that divides the light blocking unit.

In the application example, in a case where the impurities are accumulated on a position where the slit is provided, since the impurities can be kept away from the display region, it is possible to make the impurities hard to be visually recognized.

### Application Example 5

In the liquid crystal device described above, the first region is disposed so as to intersect a flowing direction of the liquid crystal molecules caused by driving of the liquid crystal.

In the application example, in the light blocking unit, since the first region is provided so as to intersect a flowing direction of the liquid crystal molecules caused by driving of the liquid crystal, the impurities moving with the flow of the liquid crystal molecules can be easily accumulated in the first region.

### Application Example 6

In the liquid crystal device described above, an orientation film including a columnar structure with inorganic material is disposed between the first substrate and the liquid crystal. The first region is disposed so as to intersect an inclination direction of the columnar crystal, when viewed in the direction toward the first substrate from the second substrate.

In the application example, in the light blocking unit, the first region is provided at a position intersecting the inclination direction of the columnar crystal in a plan view. Here, in the liquid crystal on which the orientation film having a columnar structure with inorganic material is provided, the liquid crystal molecules easily flow in the inclination direction of the columnar structure in a plan view. Therefore, in the liquid crystal device, since the first region is provided at a position intersecting the direction where the liquid crystal molecules easily flow, the impurities moving with the flow of the liquid crystal molecules can be easily accumulated in the first region.

### Application Example 7

In the liquid crystal device described above, the display region shows a rectangular shape in a plan view, and the first region is provided at the position corresponding to at least one of the four corners of the rectangle.

In the application example, the first region is provided at a position corresponding to at least one of the four corners of the display region showing the rectangular shape in a plan view. Here, in the liquid crystal device having the display region showing the rectangle in a plan view, the impurities are easily accumulated in each corners of the display region. Therefore, in the liquid crystal device, since the first region is provided at the corner where the impurities are easily accumulated, the impurities can be easily accumulated in the first region.

### Application Example 8

An electronic apparatus includes the liquid crystal device described above.

In the electronic apparatus according to the application example, by using the liquid crystal device which makes the impurities hard to be visually recognized, it is possible to easily improve the display quality of the electronic apparatus.

### BRIEF DESCRIPTION OF THE DRAWINGS

The invention will be described with reference to the accompanying drawings, wherein like numbers reference like elements.

FIGS. 1A and 1B are diagrams illustrating a schematic configuration of a liquid crystal device in the embodiment.

FIG. 2 is an equivalent circuit diagram in the embodiment.

FIGS. 3A and 3B are schematic cross-sectional views illustrating an orientation state of liquid crystal molecules in the embodiment.

FIG. 4 is a plan view illustrating a display region of the liquid crystal device in the embodiment.

FIG. 5 is a plan view illustrating an example of a light blocking film in the embodiment.

FIG. 6 is a plan view illustrating another example of a light blocking film in the embodiment.

FIG. 7 is a diagram illustrating a schematic configuration of a projector in the embodiment.

### DESCRIPTION OF EXEMPLARY EMBODIMENTS

With reference to the drawings, the embodiments will be described. In each of the drawings, in order to make the size of each configuration large enough to be easily recognized, a scale of the configurations and members may be different.

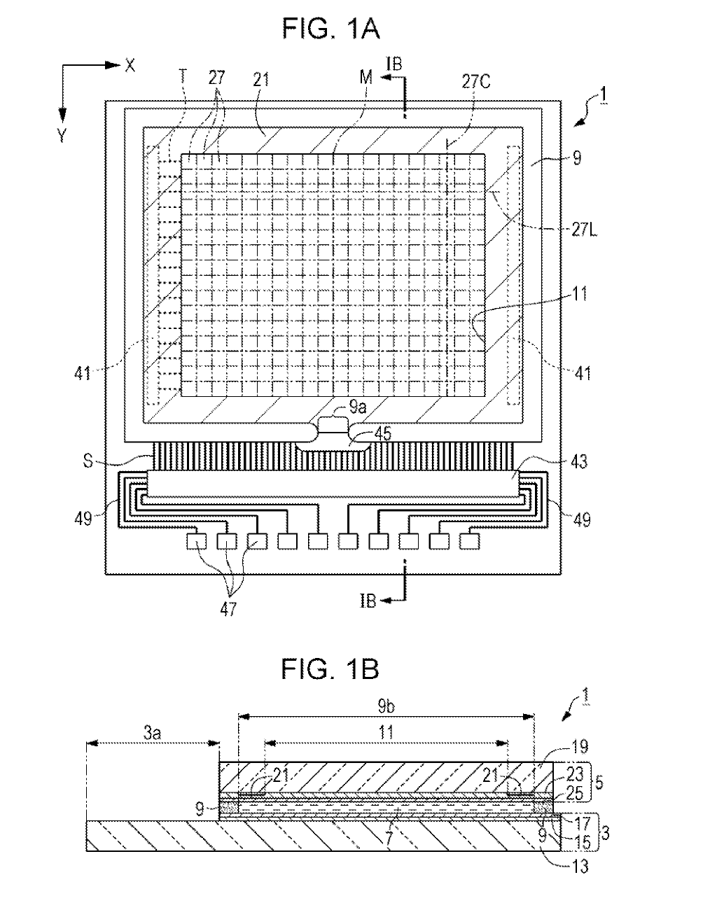

A liquid crystal device 1 in the embodiment, as illustrated in FIG. 1A, a plan view, and in FIG. 1B, a cross-sectional view along the line IB-IB in FIG. 1A, includes an element substrate 3, an opposing substrate 5, liquid crystal 7 and a seal member 9.

The element substrate 3 and the opposing substrate 5, as illustrated in FIG. 1B, are opposed to each other. The liquid crystal 7 is interposed between the element substrate 3 and the opposing substrate 5 opposed to each other. In between the element substrate 3 and the opposing substrate 5, the seal member 9 is provided on the outer side of the liquid crystal 7.

Here, in the liquid crystal device 1, as illustrated in FIG. 1A, a display region 11 is provided. The display region 11 is a region where an image is formed (displayed). In the embodiment, the display region 11 shows a rectangular shape in a plan view.

The seal member 9 is provided on the outer side of the display region 11 in an annular shape and surrounds the liquid crystal 7 from the outer side of the display region 11. The liquid crystal 7 is sealed between the element substrate 3 and the opposing substrate 5 by the seal member 9. In addition, a space partitioned by the seal member 9 and the element substrate 3 and the opposing substrate 5 is called a cell.

The element substrate 3, as illustrated in FIG. 1B, includes a substrate 13, an element layer 15 and an orientation film 17. The substrate 13 has an optical transparency. For example, glass, quartz or the like is adopted as material for the substrate 13. The element layer 15 is provided at the liquid crystal 7 side of the substrate 13. The element layer 15 includes a TFT (Thin Film Transistor) element described below, a pixel electrode and an insulation film and the like. The orientation film 17 is provided at the liquid crystal 7 side of the element layer 15.

The opposing substrate 5 includes a substrate 19, a light blocking film 21, an element layer 23 and an orientation film 25. The substrate 19 has an optical transparency. For example, glass, quartz or the like can be adopted as material for the substrate 19. The light blocking film 21 is provided at the outer side of the display region 11, and in the region 9b surrounded by the seal member 9. The light blocking film 21 surrounds the display region 11. In addition, in FIG. 1A, hatching is applied in the region of the light blocking film 21. The light blocking film 21 has transparency light blocking property. As material for the light blocking film 21, for example, metal having a light blocking property or metal oxide having a light blocking property and the like can be adopted. The element layer 23 is provided at the liquid crystal 7 side of the substrate 19. The element layer 23 includes a common electrode described below and an insulation film and the like. The orientation film 25 is provided at the liquid crystal 7 side of the element layer 23. As described below, there exists a region (a first region) where the light blocking film 21 is not disposed.

In addition, in the embodiment, the element substrate 3, as illustrated in FIG. 1B, is protruding more than the opposing substrate 5 in a plan view. In the element substrate 3, the region protruding more than the opposing substrate 5 is called an overhanging region 3a.

In the liquid crystal device 1, a plurality of pixels 27 are set. The plurality of pixels 27 are arranged in the X direction and the Y direction in the display region 11, and configure a matrix M with the X direction as a row direction and the Y direction as a column direction. In FIG. 1A, in order to highlight the configuration, the pixels 27 are exaggerated and the number of pixels 27 is reduced.

In the embodiment, the plurality of pixels 27 arranged along the Y direction configures a pixel column 27C. In addition, the plurality of pixels 27 arranged along the X direction configures a pixel row 27L. From this point of view, the X direction may also be considered to be a direction where the pixel row 27L is extended. In addition, the Y direction may also be considered to be a direction where the pixel column 27C is extended.

Furthermore, the liquid crystal device 1 includes a scanning line drive circuit 41, a data line drive circuit 43, a sealing material 45, a terminal electrode 47, a plurality of scanning lines T and a plurality of data lines S.

The scanning line drive circuit 41, the data line drive circuit 43 and the terminal electrode 47 are formed on the element substrate 3. In FIG. 1A, in order to highlight the configuration, the terminal electrodes 47 are exaggerated and the number of terminal electrodes 47 is reduced. In the embodiment, the data line drive circuit 43 is provided on the overhanging region 3a described above.

Furthermore, in the embodiment, the X direction is corresponding to the direction where the scanning line T is extended. The Y direction is corresponding to the direction where the data line S is extended.

In addition, the light blocking film 21 described above is provided in a region overlapping the peripheral circuits including the scanning line drive circuit 41 and the data line drive circuit 43.

The scanning line drive circuit 41 supplies a selection signal to the scanning line T. The data line drive circuit 43 supplies a data signal (an image signal) to the data line S.

The terminal electrode 47 is a terminal for connecting an external wiring such as an FPC (Flexible Printed Circuit). The terminal electrode 47 and the scanning line drive circuit 41 or the terminal electrode 47 and the data line drive circuit 43 are electrically connected via a wiring line 49.

In the seal member 9, an injection port 9a is formed. The injection port 9a is an introduction path for liquid crystal 7 to come into the cells. The injection port 9a has a configuration where the seal member 9 having an annular shape is partially cut out, and allows the inside and outside of the cells to communicate.

In the embodiment, as a method for injecting the liquid crystal 7 into the cell, a reduced pressure injection method is adopted. The reduced pressure injection method is a method for injecting the liquid crystal 7 into the cell by bringing the injection port 9a and the liquid crystal 7 into contact with each other under the reduced pressure environment close to vacuum, and then increasing the pressure of the reduced pressure environment.

The injection port 9a is sealed by the sealing material 45. As a result, the liquid crystal 7 is sealed in the cell.

Furthermore, the method for injecting the liquid crystal 7 into the cell is not limited to the reduced pressure injection method, and a falling-drop method (also called ODF (One Drop Fill)) can be also adopted. In a case where the falling-drop method is adopted, the injection port 9a and the sealing material 45 can be omitted.

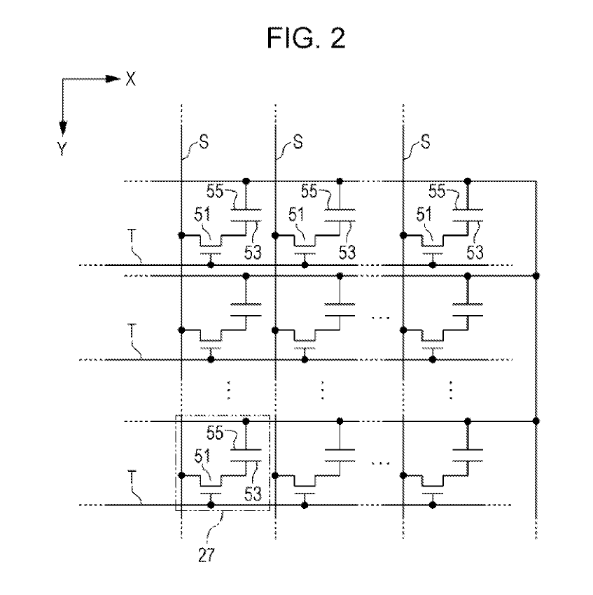

The plurality of scanning lines T and the plurality of data lines S, as described in FIG. 2, are wired in a lattice. The plurality of scanning lines T extends along the X direction with spacing from each other in the Y direction. The plurality of data lines S extends along the Y direction with spacing each other in the X direction. Each pixel 27 is set corresponding to the intersection of each scanning line T and each data line S.

Each data line S corresponds to the plurality of pixels 27 arranged along the Y direction, that is, each pixel column 27C (FIG. 1A). Each scanning line T corresponds to the plurality of pixels 27 arranged along the X direction, that is, each pixel row 27L (FIG. 1A).

In addition, the liquid crystal device 1 includes a TFT element 51 which is one of switching elements, a pixel electrode 53 and a common electrode 55 for each pixel 27. In addition, the common electrode 55 is provided in a state of series crossing between the plurality of pixels 27 which configure the matrix M. In other words, the common electrode 55 is provided in the region overlapping the plurality of pixels 27 in a plan view which configures the matrix M, and functions in common crossing between the plurality of pixels 27.

A gate electrode of the TFT element 51 is electrically connected to the corresponding scanning line T. A source electrode of the TFT element 51 is electrically connected to the corresponding data line S. In each of the pixels 27, a drain electrode of the TFT element 51 is electrically connected to the pixel electrode 53.

In each of the pixels 27, the pixel electrode 53 and the common electrode 55 configures a pair of electrodes which form an electric field between the pixel electrode 53 and the common electrode 55. The liquid crystal 7 (FIG. 1B) is interposed between the pixel electrode 53 and the common electrode 55. In the embodiment, the pixel electrode 53 and the common electrode 55 are opposed to each other.

The TFT element 51 becomes ON state when a selection signal is supplied to the scanning line T which is electrically connected to the TFT element 51. At this time, a data signal is supplied the data line S which is electrically connected to the TFT element 51, and the pixel electrode 53 is maintained at an electric potential corresponding to the magnitude of the data signal. In this case, in a case where the common electrode 55 is maintained at a different electric potential from that of the pixel electrode 53, a voltage is generated between the pixel electrode 53 and the common electrode 55. In this way, for each pixel 27, it is possible to apply a voltage between the pixel electrode 53 and the common electrode 55.

In the liquid crystal device 1, by changing the voltage applied between the pixel electrode 53 and common electrode 55, it is possible to change the orientation state of the liquid crystal 7 for each pixel 27. In this way, it is possible to drive the liquid crystal 7 for each pixel 27.

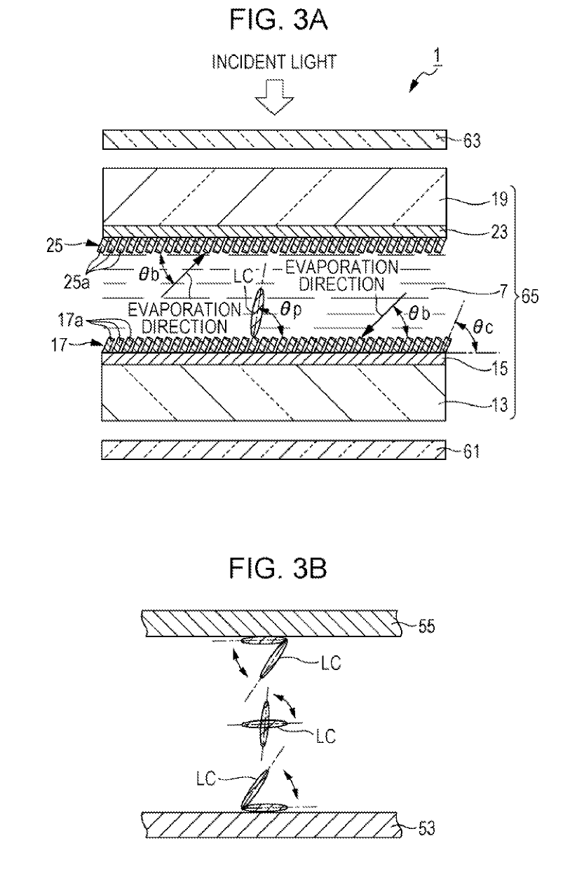

In the liquid crystal device 1, as illustrated in FIG. 3A which is a schematic cross-sectional view illustrating the initial orientation state of liquid crystal molecules, a polarization element 61 is provided on the opposite side to the liquid crystal 7 side of the substrate 13 and a polarization element 63 is provided on the opposite side of the liquid crystal 7 side of the substrate 19. The liquid crystal device 1 is used in the state in which the polarization element 61 and the polarization element 63 are provided. In this state, by controlling the drive of the liquid crystal 7, it is possible to control, for each pixel 27, the light amount transmitting the liquid crystal device 1. In addition, in liquid crystal device 1, the configuration from the substrate 13 to the substrate 19 is called a liquid crystal panel 65.

In the embodiment, a transmission axis (or an absorption axis) of one of the polarization element 61 and polarization element 63 extends in the X direction or Y direction. Furthermore, the transmission axis (or the absorption axis) of each polarization element 61 and the polarization element 63 are orthogonal to each other.

As for the molecules of the liquid crystal 7, the initial orientation state is kept by an orientation film 17 and an orientation film 25. The initial orientation state is an orientation state where the voltage is not applied between the pixel electrode 53 and the common electrode 55. In addition, in the embodiment, as a method for driving the liquid crystal 7, a VA (Vertical Alignment) type drive method is adopted.

In the embodiment, as the orientation film 17 and the orientation film 25, an inorganic orientation film is adopted respectively. The inorganic orientation film, for example, is composed of the inorganic material such as silicon oxide. The inorganic orientation film may be formed by using a physical vapor deposition method. AS the physical vapor deposition, for example, an evaporation method and a sputtering method and the like may be recommended.

The orientation film 17 and the orientation film 25 are formed by a deposition of silicon oxide using an oblique vapor deposition (oblique evaporation). An inclination angle θb of the oblique vapor deposition illustrated in FIG. 3A is approximately 45°. BY the oblique vapor deposition, a crystalline body of silicon oxide is grown on the substrate surface in the evaporation direction in a columnar shape. The column-shaped crystalline body is called column 17a and column 25a respectively. The orientation film 17 and the orientation film 25 are collections of the column 17a and column 25a respectively. In addition, a growth direction angle θc of the column 17a and the column 25a with respect to the substrate surface is not necessarily same as the angle θb of the evaporation direction. In this case, the angle θc is approximately 70°.

On the surfaces of the orientation film 17 and the orientation film 25, a pre-tilt angle θp of a vertically oriented crystal molecules LC is approximately 85°. In addition, a pre-tilt direction of tilting the liquid crystal molecules LC viewed from the normal direction of the substrate surface, that is, a tilt direction is same as the evaporation direction of the oblique vapor deposition in a plan view in the orientation film 17 and the orientation film 25. The tilt direction in a vertical orientation process is appropriately set based on an optical design condition of the liquid crystal device 1.

An orientation state in which the liquid crystal molecules LC having a negative dielectric anisotropy with respect to the surface of the orientation film is given the pre-tilt angle θp of less than 90° and stands inversely, is called a vertical orientation.

In the embodiment, in the display region 11, a vertical orientation process is performed so that the intersection occurs when the pre-tilt azimuth of the liquid crystal molecules LC is 45° with respect to the transmission axis or the absorption axis of the polarization element 61 and the polarization element 63. Accordingly, as illustrated in FIG. 3B, when the drive voltage is applied between the pixel electrode 53 and the common electrode 55 to drive the liquid crystal 7, by the fact that the liquid crystal molecules LC fall down to the tilt direction of the pre-tilting, the optical arrangement is likely to obtain a higher transmittance.

By repeating the drive (ON/OFF) of the liquid crystal 7, the liquid crystal molecules repeat the behavior of falling down to the tilt direction and coming back to the initial orientation state. The vertical orientation process where the liquid crystal LC behaves like this is called one axis vertical orientation process.

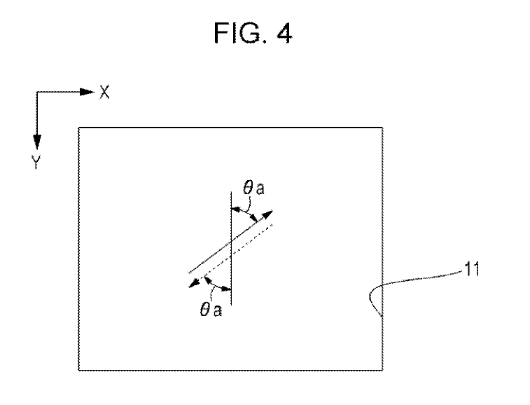

As illustrated in FIG. 4, the tilt direction of the pre-tilting of the liquid crystal molecules LC in the display region 11 is set so that the azimuth angle θa forming the Y direction is 45°. Specifically, an arrow direction shown in dashed line is a direction of the oblique vapor deposition with respect to the element substrate 3 and is a direction from the upper right to the lower left. On the other hand, an arrow direction shown in real line is a direction of the oblique vapor deposition with respect to the opposing substrate 5 and is a direction from the lower left to the upper right. Using the azimuth angle θa as it is, the tilt direction of the pre-tilting of the liquid crystal molecules LC in the display region 11 is called the tilt direction θa. In addition, the column 17a and the column 25a extends respectively in the tilt direction θa in a plan view (in FIG. 4).

Incidentally, in the liquid crystal device 1, when the light is incident from the opposing substrate 5 side to the liquid crystal device 1, the impurities may be accumulated between the opposing substrate 5 and the element substrate 3 and also the boundary between the light blocking film 21 and the display region 11. It is considered that it is because the impurities activated by the light irradiation are easily accumulated to the light blocking film 21 side where the light irradiation energy is weak compared to the image display region 11. Then, the accumulated impurities generate a burning phenomenon and it is likely to be visually recognized as a spot. Such spots may be a factor of decreasing the display quality of the liquid crystal device 1.

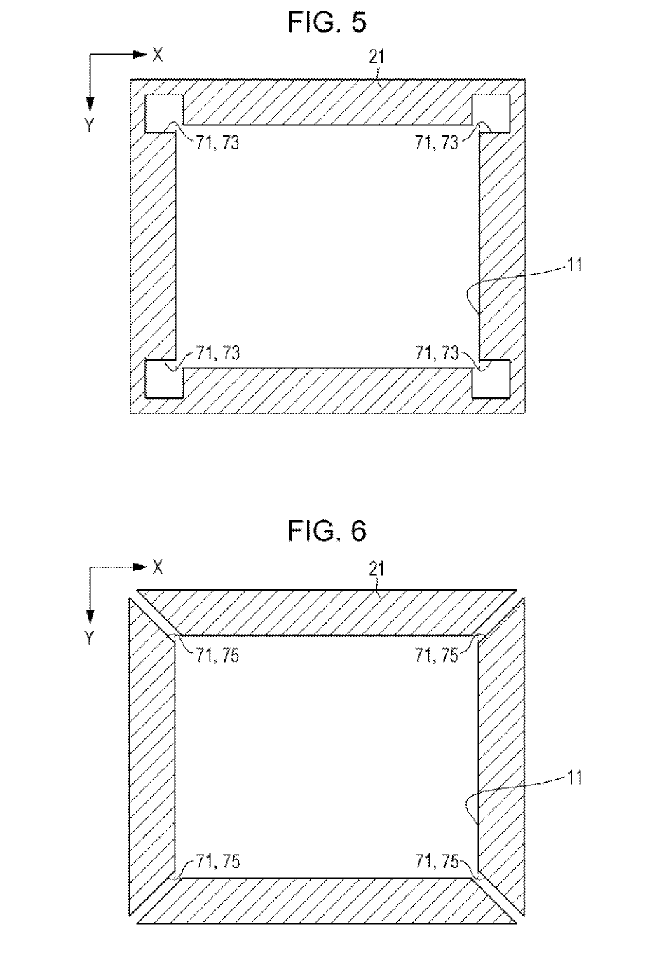

In the liquid crystal device 1 in the embodiment, as illustrated in FIG. 5, a groove 71 is provided in the light blocking film 21 toward the outer side of the display region 11 from the display region 11 side. In the example illustrated in FIG. 5, a notch 73 is provided as the groove 71. By the groove 71, it is possible to keep the boundary between the light incidence and the light blocking away from the outer side of the display region 11. As a result, in a case where the impurities are accumulated in the position where the groove 71 is provided, since the impurities can be kept away from the display region 11, it is possible to make the impurities hard to be visually recognized. In this way, it is possible to easily improve the display quality of the liquid crystal device 1. The region where the groove 71 is provided is the first region. The groove is formed by means of patterning the light blocking film 21 or the like.

As described above, in the embodiment, the one axis vertical orientation is adopted. According to the tilt direction θa in the embodiment, by driving the pixel 27, the liquid crystal molecules LC vertically oriented with respect to the substrate surface show a behavior of vibrating in the tilt direction θa (refer to FIG. 3B). As a result, the behavior of the liquid crystal molecules LC toward the tilt direction θa, that is, liquidity (the flow) is generated. Accordingly, the impurities contained in the liquid crystal 7 are moving through the liquid crystal 7 along the liquidity (the flow), and is carried to the corners located in the tilt direction θa in the display region 11 before long. Therefore, the impurities can be easily accumulated in the corners of the display region 11.

In the embodiment, the grooves 71 are provided on the position of light blocking film 21 which intersects the flowing direction of the liquid crystal molecules LC caused by driving the liquid crystal 7, that is, on the four corners of the display region 11. Therefore, the impurities moving with the flow of the liquid crystal molecules LC can be easily accumulated in the grooves 71. In this way, impurities can be effectively and easily accumulated in the grooves 71.

Furthermore, in the embodiment, the grooves 71 are provided on the four corners of the display region 11. However, the place where the grooves are provided is not limited thereto, the grooves 71 may be provided on at least one corner which intersects a flowing direction of the liquid crystal molecules LC. Furthermore, in addition to the four corners, a configuration on which the grooves 71 are also provided on other places may be adopted.

In addition, a shape of the notch 73 is not limited to the example illustrated in FIG. 5, various shapes such as a circular shape or other shapes may be adopted.

In addition, the aspect of the grooves 71 is not limited to the notch 73, the slit 75 may be adopted as illustrated in FIG. 6. The slit 75 divides the light blocking film 21 into plural with the slit 75 as a boundary. By adopting such slit 75 also, since the impurities can be kept away from the display region 11, it is possible to make the impurities hard to be visually recognized. In this way, it is possible to easily improve the display quality of the liquid crystal device 1. In addition, the shape of the slit 75 is not limited to the example illustrated in FIG. 5, various shapes such as the shapes including the curves may be adopted. The slit 21 is formed by means of patterning the light blocking film 21 or the like.

In the embodiment, the opposing substrate 5 is corresponding to the first substrate, and the element substrate 3 is corresponding to the second substrate.

Furthermore, in the embodiment, as the orientation film 17 and the orientation film 25, an inorganic orientation film is adopted respectively. However, the orientation film 17 and the orientation film 25 are not limited to the inorganic orientation film respectively. As the orientation film 17 and the orientation film 25, for example, an organic orientation film of polyimide or the like may be adopted.

In addition, in the embodiment, the liquid crystal 7 with VA type is applied, but not limited thereto. As the liquid crystal 7, for example, a TN (Twisted Nematic) type or an OCB (Optically Compensated Bend) type may also be adopted.

In the embodiment, as the liquid crystal device 1, a transmission type liquid crystal device 1 is adopted. However, the liquid crystal device 1 is not limited thereto. As the liquid crystal device 1, for example, a reflection type liquid crystal device 1 may also be adopted in which the pixel electrode 53 is composed of the materials having a light reflectivity.

### Electronic Apparatus

An electronic apparatus using the liquid crystal device 1 will be described with a projector which is one of the reflection type liquid crystal device 1 as an example.

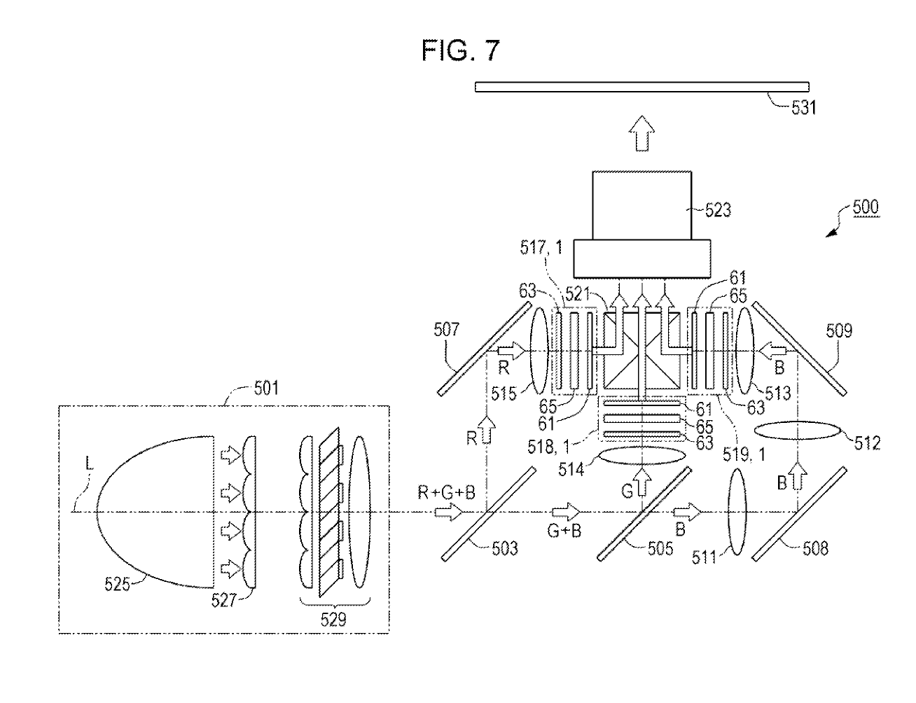

The projector 500 in the embodiment, as illustrated in FIG. 7, includes a polarization illuminating device 501 disposed along the system light axis L, two dichroic mirrors 503 and 505 as a beam splitter, three reflection mirrors 507, 508 and 509, five relay lenses 511, 512, 513, 514, and 515, three transmission type liquid crystal light valves 517, 518 and 519 as optical modulation means, a cross dichroic prism 521 as a photosynthesis element, and a projection lens 523.

The polarization illuminating device 501 includes a lamp unit 525 as a light source consisting of white light sources such as ultrahigh pressure mercury lamps and halogen lamps, an integrator lens 527 and a polarization conversion element 529.

The dichroic mirror 503 reflects the red light (R), and transmits the green light (G) and the blue light (B) among the polarization light flux emitted from the polarization illumination device 501. Another dichroic mirror 505 reflects the green light (G) transmitted through the dichroic mirror 503, and transmits the blue light (B).

The red light (R) reflected by the dichroic mirror 503 is incident on the liquid crystal light valve 517 via the relay lens 515 after being reflected by the reflection mirror 507.

The green light (G) reflected by the dichroic mirror 505 is incident on the liquid crystal light valve 518 via the relay lens 514.

The blue light (B) transmitted through the dichroic mirror 505 is incident on the liquid crystal light valve 519 via a light guide system composed of three relay lenses 511, 512 and 513 and two reflecting mirrors 508 and 509.

The liquid crystal light valves 517, 518 and 519 are respectively disposed opposite to the incidence surface for each color light of the cross dichroic prism 521. The color light incident to the liquid crystal light valves 517, 518 and 519 are modulated based on the video information (a video signal) to be emitted toward the cross dichroic prism 521. The prism is formed of four rectangular prisms bonded each other, on the inner side of which a dielectric multilayer film that reflects red light and a dielectric multilayer film that reflects blue light are formed in a shape of cross. Three color lights are synthesized by the dielectric multilayer film, light that represents the color image is synthesized. The synthesized light is projected on the screen 531 by the projection lens 523 which is a projection optical system, and the image is enlarged and displayed.

Furthermore, as for the liquid crystal valves 517, 518 and 519, the liquid crystal device 1 described above is applied respectively. The polarization element 63 side of each liquid crystal valves 517, 518 and 519 is directed toward the light incident side of each color light.

According to the projector 500 in the embodiment, since the projector 500 includes the liquid crystal device 1 in which the impurities are hard to be visually recognized, it is possible to easily improve the display quality of the projection display.

Furthermore, the electronic apparatus where the liquid crystal device 1 is applied is not limited to the projector 500. The liquid crystal device 1, for example, may be suitably used as a display unit of the information terminal apparatus such as a projection type HUD (a head-up display) and a direct view type HMD (a head-mount display), or an electronic book, a personal computer, a digital still camera, a liquid crystal television set, a view finder type or a direct view type video recorder, a car navigation system, an electronic diary and POS.

In addition, the invention is not limited to the above-described embodiments, and may be applied to wide ranges within the scope of the invention. The entire disclosure of Japanese Patent Application No. 2012-098460, filed Apr. 24, 2012 is expressly incorporated by reference herein.

What is claimed is:

1. A liquid crystal device comprising:
a first substrate;
a second substrate;
a liquid crystal interposed between the first substrate and the second substrate;
a light blocking unit disposed in a region surrounding a display region when viewed in a direction toward the first substrate from the second substrate; and
a first region that surrounds the display region together with the light blocking unit,
wherein the first region is disposed toward the outer periphery of the first substrate and/or the second substrate from the display region, when viewed in the direction toward the first substrate from the second substrate.

2. The liquid crystal device according to claim 1,
wherein a light blocking film is not disposed in the first region.

3. The liquid crystal device according to claim 1,
wherein impurities included in the liquid crystal are accumulated in the first region.

4. The liquid crystal device according to claim 1,
wherein the light blocking unit is disposed on the opposite surface to the light incident side surface of the first substrate.

5. The liquid crystal device according to claim 1,
wherein the first region is provided so as to cut into a part of the light blocking unit.

6. The liquid crystal device according to claim 1,
wherein the first region is a slit that divides the light blocking unit.

7. The liquid crystal device according to claim 1,
wherein the first region is disposed so as to intersect a flowing direction of the liquid crystal molecules caused by driving the liquid crystal.

8. The liquid crystal device according to claim 1,
wherein an orientation film including a columnar structure of inorganic material is disposed between the first substrate and the liquid crystal, and
wherein the first region is disposed so as to intersect an inclination direction of the columnar structure, when viewed in the direction toward the first substrate from the second substrate.

9. The liquid crystal device according to claim 1,
wherein the display region is a rectangle when viewed in the direction toward the first substrate from the second substrate, and
wherein the first region is disposed at a position corresponding to at least one of the four corners of the rectangle.

10. An electronic apparatus comprising:
the liquid crystal device according to claim 1.

11. An electronic apparatus comprising:
the liquid crystal device according to claim 2.

12. An electronic apparatus comprising:
the liquid crystal device according to claim 3.

13. An electronic apparatus comprising:
the liquid crystal device according to claim 4.

14. An electronic apparatus comprising:
the liquid crystal device according to claim 5.

15. An electronic apparatus comprising:
the liquid crystal device according to claim 6.

16. An electronic apparatus comprising:
the liquid crystal device according to claim 7.

17. An electronic apparatus comprising:
the liquid crystal device according to claim 8.

18. An electronic apparatus comprising:
the liquid crystal device according to claim 9.
